(19) United States
(12) Patent Application Publication
(10) Pub. No.: US 2007/0001465 A1
(43) Pub. Date: Jan. 4, 2007

(54) WINDMILL FUNNEL AND METHOD OF INCREASING WINDMILL OUTPUT

(76) Inventor: Harris E. Smith, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 11/426,895

(22) Filed: Jun. 27, 2006

Related U.S. Application Data
(60) Provisional application No. 60/696,042, filed on Jul. 1, 2005.

(51) Int. Cl. F03D 9/00

(52) U.S. Cl. 290/55

(57) ABSTRACT

An apparatus for improving the generation of wind-powered energy is configured to be placed in front of a windmill. The apparatus has an entry aperture spaced from the windmill blades and having an entry aperture dimension that is greater than the tip-to-tip span of the rotatable windmill blades. The apparatus further includes an exit aperture that is located adjacent the windmill blades and dimensioned substantially equal to the tip-to-tip span of the rotatable blades. Further, a funnel material is spanned between the entry and exit apertures and is adapted to guide wind received within the entry aperture toward the exit aperture and thence to the rotatable blades of the windmill so that a speed of the wind is increased as the wind passes from the entry aperture to the windmill blades.

### CROSS-REFERENCE TO RELATED APPLICATIONS

This application claims the benefit from U.S. Provisional Patent Application No. 60/696,042 filed Jul. 1, 2005 whose contents are incorporated herein for all purposes.

### BACKGROUND OF THE INVENTION

1. Field of the Invention

The present application relates to windmills and more specifically to fixed-direction power-generating windmills.

2. Description of the Prior Art

As fossil fuel costs and concerns about global warming rise, wind-generated power becomes more and more attractive. Massive “wind farms” are being constructed or planned throughout the globe in the hopes of harnessing this freely available, constantly renewable energy source.

To make wind power feasible, however, the efficiencies of windmills must be improved. Over the last few decades, improvements in wind power efficiency has led to the development of arrays of large, fixed-direction windmills equipped with highly efficient turbine blades mounted on tall, sturdy steel masts. These arrays of windmills harness prevailing direction winds to generate and supply electrical power to the power grid. But even these advanced “wind farms” fail to produce the amounts of energy needed to power our energy-hungry needs.

Thus, it is desirable to increase the output of these giant wind farms in order to produce more clean and renewable energy and take advantage of available power that is currently being wasted.

### SUMMARY OF THE PRESENT DISCLOSURE

In one embodiment, an apparatus for generating wind-powered energy comprises a windmill having rotatable blades. The blades have a tip-to-tip span and are adapted to rotate responsive to wind imparted to the blades. An entry aperture is spaced from the windmill blades which has an aperture dimension greater than the tip-to-tip span of the windmill blades. An exit aperture is located adjacent the windmill blades and dimensioned substantially equal to the tip-to-tip span of the rotatable blades. Further, a funnel material is spanned between the entry and exit apertures. The material is adapted to guide wind received within the entry aperture toward the exit aperture and thence to the rotatable blades of the windmill so that a speed of the wind is increased as the wind passes from the entry aperture to the windmill blades.

According to another embodiment, the present disclosure provides a method for increasing wind speed to a windmill. The method calls for disposing a funnel upwind of a windmill. The funnel has a wind-entry aperture spaced from the windmill and a wind-exit aperture adjacent the windmill. The wind-entry aperture is dimensioned to be greater than a dimension of the wind-exit aperture. In operation, allowing wind to pass through the wind-entry aperture causes a gain in speed as the wind passes through the funnel to the wind-exit aperture.

In yet another embodiment, an apparatus is provided for increasing power generating capabilities of a windmill which has rotatable blades with a tip-to-tip span adapted to rotate in response to wind imparted to the blades. The apparatus comprises an entry aperture spaced from the windmill blades. The entry aperture preferably has an aperture dimension greater than the tip-to-tip span of the rotatable windmill blades. Also, an exit aperture, located adjacent the windmill blades, is dimensioned substantially equal to the tip-to-tip span of the rotatable windmill blades. Further, a material is spanned between the entry and exit apertures. The material is adapted to guide the wind received within the entry aperture toward the exit aperture and thence to the rotatable blades of the windmill. Thus increasing speed of the wind as it passes from the entry aperture to the windmill blades.

### BRIEF DESCRIPTION OF THE DRAWINGS

FIG. 1 is a side elevation view of a windmill and a windmill funnel according to an embodiment of the invention.

FIG. 2 is a front elevation view of the windmill funnel of FIG. 1.

FIG. 3 is a top plan view of the windmill and windmill funnel of FIG. 1.

### DETAILED DESCRIPTION

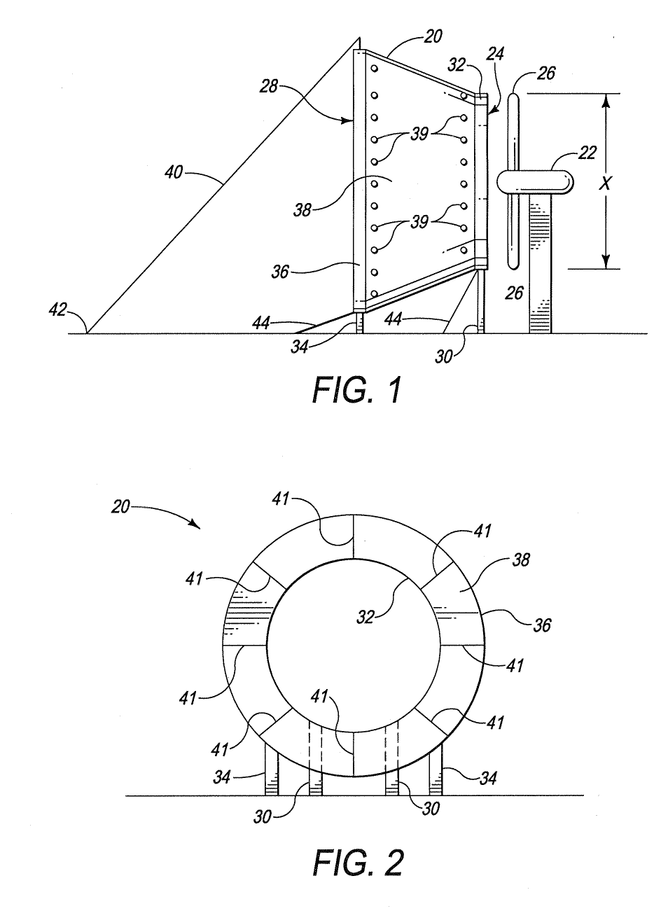

FIG. 1 is a side elevation view (not to scale) of windmill funnel 20 according to an embodiment of the invention positioned in front of fixed-direction power-generating windmill 22. The diameter of the exit aperture 24 is shown to be equal to the distance x from tip-to-tip of the windmill blades 26. The distance x can be greater than 35 feet. The diameter of the entry aperture 28 can be sized such that the entry aperture 28 has roughly twice the area of the exit aperture 24.

In one embodiment, the entry aperture 28 and exit aperture 24 may be formed with a steel tubular structure 36 and 34. A back post(s) 30 may be placed to support the steel tubular structure 32, and a front post(s) 34 may be placed to support the steel tubular structure 36. Funnel material 38 is attached to the tubular structures 32 and 36 to form the funnel shape. Funnel material 38 should be a material that is tough enough to resist wind pressures yet light and pliable enough to form into the funnel shape. The funnel material 38 can be affixed to the tubular structures with grommets 39.

One possible funnel material 38 is the disposed felt material used by paper mills over which slurry is run within the mill. This felt material is easily and cheaply available because it is material that is disposed of as solid waste at every paper mill. The material can be relatively easily cut and riveted together to form the funnel material 38.

A front stabilizing cable 40 can be attached at the top of the entry aperture 28 and is anchored in the ground by anchor 42 to provide added resistance to wind pressure and general stabilization of the funnel structure 20. Additional stabilizing cables 44 can also be added to the front, rear, and or sides of both entry 28 and exit 24 apertures.

FIG. 2 is a front elevation view of the funnel structure 20. Two front posts 34 are shown supporting the funnel structure 20 at the entry aperture 28. Two rear posts 30 support funnel structure 20 at the exit aperture 24. The funnel material 38 is shown as sections fastened together that are attached to the front and rear tubular structures 32 and 36.

Supports 41 may be configured to span between the entry 28 and exit 24 apertures. In one embodiment, such supports 41 may be implemented using cables. The supports 41 give shape and support to the funnel material 38 that is wrapped around the supports 41 and affixed around the entry 28 and exit 24 apertures.

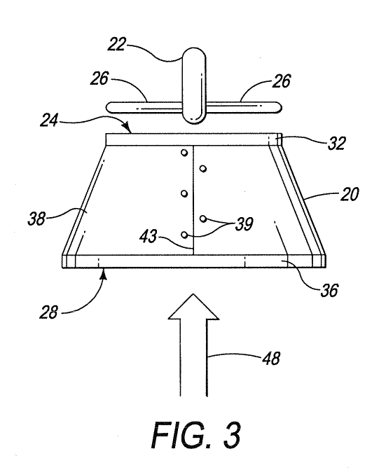

FIG. 3 is a top plan view of the windmill funnel 20 and the power-generating windmill 22 of FIG. 1. The funnel 20 is shown positioned close to the windmill blades 26. The wind 48 is shown as a prevailing direction wind that enters the large opening 28 of the funnel 20. The funnel material 38 then acts like a venturi jet and increases the speed of the wind 48 at the small opening 24 and thus feeds this increased-speed wind to the windmill blades 26. The venturi effect of the funnel 20 can increase the speed of the windmill blades 26 and thus increase the energy output of the windmill 22.

The funnel material 38 can be a single piece of material that is wrapped around the cables 41 (see FIG. 2) and affixed to itself along seam 43 with grommets 39. The grommets 39 can be alternately spaced on either side of seam 43 to provide added structural strength and stability.

Having described and illustrated the principles of the invention in a preferred embodiment thereof, it should be apparent that the invention can be modified in arrangement and detail without departing from such principles. The invention is applicable to use with horizontal or vertical axis turbines where the exit aperture of the wind funnel is sized in accordance with the dimension of the windmill blades used. Although shown in the drawings as having annular-shaped openings with a frusto-conical funnel, for instance, it is understood that windmill funnel 20 can have an assortment of shapes including square openings with flat surfaces coupling entry and exit apertures 28, 24 without departing from the spirit of the invention. Furthermore, the adjacency of the windmill blades to the exit aperture 24 can mean that the blades are within aperture 24, or spaced therefrom as shown in the drawings. We claim all modifications and variation coming within the spirit and scope of the following claims.

What is claimed is:

1. An apparatus for generating wind-powered energy comprising:
a windmill having rotatable blades with a tip-to-tip span adapted to turn around a rotational axis responsive to wind imparted to the blades;
an entry aperture spaced from the windmill blades and having an entry aperture dimension greater than the tip-to-tip span of the rotatable blades of the windmill;
an exit aperture located adjacent the windmill blades and dimensioned substantially equal to the tip-to-tip span of the rotatable blades of the windmill; and
a funnel material spanning between the entry aperture and exit aperture adapted to guide wind received within the entry aperture toward the exit aperture and thence to the rotatable blades of the windmill so that a speed of the wind is increased as the wind passes from the entry aperture to the windmill blades.

2. The apparatus of claim 1, wherein said entry aperture and said exit aperture are annular in shape and the funnel material spanning between the entry and exit apertures forms a frusto-conical shape.

3. The apparatus of claim 1, wherein the entry aperture has an entry aperture dimension approximately twice the dimension of the exit aperture.

4. The apparatus of claim 1, wherein the funnel material is a disposed felt material.

5. The apparatus of claim 1, further including a steel tubular structure that defines the entry and exit apertures, said funnel material attached to said tubular structure.

6. The apparatus of claim 5, further including a plurality of cables spanning between the tubular structure of the entry and exit apertures, said funnel material wrapped around said cables to form a funnel shape.

7. The apparatus of claim 6, wherein said funnel material is affixed to itself along a seam with a plurality of grommets.

8. The apparatus of claim 6, wherein said grommets are alternately spaced on either side of the seam.

9. The apparatus of claim 5, further including support posts coupled to the steel tubular structure adapted to support said tubular structure above the ground.

10. The apparatus of claim 5, further including at least one stabilizing cable attached at one end to at least one of the tubular structures, and at another end to a ground anchor.

11. A method for increasing wind speed to a windmill, the method comprising:
disposing a funnel upwind of a windmill, the funnel comprising a wind-entry aperture spaced from the windmill and a wind-exit aperture located adjacent the windmill, said wind-entry aperture dimensioned to be greater than a dimension of the wind-exit aperture; and
allowing wind to pass through the wind-entry aperture and gain speed as the wind passes through the funnel to the wind-exit aperture.

12. The method of claim 11, further including the steps of:
dimensioning the exit-aperture to be substantially similar to a tip-to-tip span of the windmill blades; and
elevating the funnel above the ground so that the exit-aperture is immediately adjacent a rotation path of the windmill blades when elevated from the ground.

13. An apparatus for increasing power generating capabilities of a windmill having rotatable blades with a tip-to-tip span adapted to turn around a rotational axis responsive to wind imparted to the blades, said apparatus comprising:
an entry aperture spaced from the windmill blades and having an entry aperture dimension greater than the tip-to-tip span of the rotatable blades of the windmill;
an exit aperture located adjacent the windmill blades and dimensioned substantially equal to the tip-to-tip span of the rotatable blades of the windmill; and
a material spanning between the entry aperture and exit aperture adapted to guide wind received within the entry aperture toward the exit aperture and thence to the rotatable blades of the windmill so that a speed of the wind is increased as the wind passes from the entry aperture to the windmill blades.

14. The apparatus of claim 13, wherein said entry aperture and said exit aperture are annular in shape and the material spanning between the entry and exit apertures forms a frusto-conical shape.

15. The apparatus of claim 13, wherein the entry aperture has an entry aperture dimension approximately twice the dimension of the exit aperture.

16. The apparatus of claim 13, wherein the material is a disposed felt material.

17. The apparatus of claim 13, further including a steel tubular structure that defines the entry and exit apertures, said funnel material attached to said tubular structure.

18. The apparatus of claim 13, further including a plurality of supports spanning between the entry and exit apertures, said material configured to use the supports to form a funnel shape.

19. The apparatus of claim 13, further including at least one support post coupled to the apparatus and adapted to support said apparatus above the ground.

20. The apparatus of claim 17, further including at least one stabilizing cable attached at one end to at least one of the tubular structures, and at another end to a ground anchor.
